(19) United States
(12) Patent Application Publication
(10) Pub. No.: US 2024/0300277 A1
(43) Pub. Date: Sep. 12, 2024

(54) DAMPING SYSTEM FOR A WHEEL OF A MOTOR VEHICLE

(71) Applicant: Dr. Ing. h.c. F. Porsche Aktiengesellschaft, Stuttgart (DE)

(72) Inventors: Christian Bühler, Korntal-Münchingen (DE); Andreas Freuer, Ludwigsburg (DE); Jochen Liebold, Stuttgart (DE); Jan Ranzinger, Bad Liebenzell (DE)

(73) Assignee: Dr. Ing. h.c. F. Porsche Aktiengesellschaft, Stuttgart (DE)

(21) Appl. No.: 18/423,366

(22) Filed: Jan. 26, 2024

(30) Foreign Application Priority Data
Mar. 9, 2023 (DE) 102023105815.0

(51) Int. Cl. B60G 17/08

(52) U.S. Cl. CPC B60G 17/08; B60G 2202/413; B60G 2500/11

(57) ABSTRACT

A damping system of an active chassis for a vehicle wheel. The damping system includes a double-acting hydraulic cylinder and a damper having a piston, which damper is couplable to a wheel suspension system for the wheel. A hydraulic pump has a hydraulic reservoir and a hydraulic unit including valves. The hydraulic pump and the hydraulic unit cooperate with hydraulic chambers of the hydraulic cylinder such that, depending on the direction of conveyance of the hydraulic pump of the hydraulic unit, a movement of the piston in a first direction of actuation or in a second direction of actuation can be provided. The hydraulic pump and the damper are connected via the hydraulic unit and a tube-hose system including tubes and hoses. The hydraulic cylinder of the damper and the tube-hose system of the damping system feature a combined hydraulic capacity of between 9 mL/100 bar and 14 mL/100 bar.

### CROSS-REFERENCE TO RELATED APPLICATION

This application claims priority to German Patent Application No. 10 2023 105 815.0, filed Mar. 9, 2023, the content of such application being incorporated by reference herein in its entirety.

### FIELD OF THE INVENTION

The invention relates to a damping system of an active chassis for a wheel of a motor vehicle, and to a motor vehicle.

### BACKGROUND OF THE INVENTION

DE 10 2017 117 658 B4 and DE 10 2019 115 492 B4, which are each incorporated by reference herein, each disclose a damping system of an active chassis for a wheel of a motor vehicle comprising a damper, a hydraulic pump driven by an electric motor, a hydraulic reservoir, and a plurality of valves. The damper is formed from a double-acting hydraulic cylinder and a reciprocating piston within the same. The hydraulic pump is coupled to hydraulic chambers of the hydraulic piston via hydraulic lines, whereby movement of the piston in a first actuation direction or in a second actuation direction is provided depending on the direction of conveyance of the hydraulic pump. The valves are check valves as well as damping valves.

Such an active chassis damping system is subjected to highly dynamic loads while traveling. The same is intended to have both advantageous dynamic properties in terms of providing a high force gradient and advantageous acoustic properties in terms of low noise levels.

Damping systems known from practical experience provide a sufficiently large hydraulic reservoir for this purpose. However, this is disadvantageous for reasons of weight and installation space.

DE 10 2019 111 980 A1, DE 10 2019 118 384 A1, DE 10 2010 010 869 A1 and DE 102 21 276 A1 as well as DE 10 2009 034 852 A1, as well as EP 1 344 957 A1, each of which are incorporated by reference herein, disclose further details of damping systems of active chassis of motor vehicles.

### SUMMARY OF THE INVENTION

Described herein is a damping system of an active chassis of a motor vehicle for a wheel of the motor vehicle, which, at a low weight and construction space requirement, features both advantageous dynamic properties in the sense of providing a high force gradient and advantageous acoustic properties in terms of low noise generation. A motor vehicle having such a damping system is also intended to be provided.

The damping system according to aspect of the invention comprises a damper comprising a double-acting hydraulic cylinder and a piston, the damper being couplable to a wheel suspension system for the wheel.

The damping system according to aspect of the present invention further comprises a hydraulic pump and a hydraulic unit comprising a hydraulic reservoir and valves. The hydraulic unit is preferably installed on the damper or integrated into the damper.

The hydraulic pump and the hydraulic unit cooperate with hydraulic chambers of the hydraulic cylinder such that, depending on the direction of conveyance of the hydraulic pump, movement of the piston in a first direction of actuation or in a second direction of actuation can be provided.

In the damping system according to aspect of the invention, the hydraulic pump and the damper are connected via the hydraulic unit and a tube-hose system consisting of tubes and hoses. Preferably, the hydraulic pump is connected to the hydraulic unit installed on the damper via the tube-hose system such that, starting from the hydraulic pump, first the tubes and then the hoses of the tube-hose system extend towards the hydraulic unit and the hydraulic cylinder.

The hydraulic cylinder of the damper and the tube-hose system of the damping system, as well as a hydraulic oil used in the damping system, feature a combined hydraulic capacity of between 9 Ml/100 bar and 14 Ml/100 bar.

By means of the above combination of features, both advantageous dynamic properties and advantageous acoustic properties of the damping system of the active chassis can be provided at a low weight and requiring little installation space.

Preferably, the hydraulic cylinders of the damper and the tube-hose system of the damping system, as well as the hydraulic oil used in the damping system, in the first direction of operation of the piston, in particular in the rebound direction, feature a combined hydraulic capacity of between 10 Ml/100 bar and 14 Ml/100 bar, preferably between 11 Ml/100 bar and 13 Ml/100 bar, particularly preferably between 11.5 Ml/100 bar and 12.5 Ml/100 bar, and, in the in the second actuation direction of the piston, in particular in the compression direction, a hydraulic capacity of between 9 Ml/100 bar and 12 Ml/100 bar, preferably between 10.5 Ml/100 bar and 11.5 Ml/100 bar, particularly preferably between 10 Ml/100 bar and 11 Ml/100 bar. These hydraulic capacities in the rebound direction and compression direction of the damper are particularly preferable in order to provide advantageous dynamic and acoustic properties at a low weight and requiring little installation space.

Preferably, in the first actuation direction, in particular in the rebound direction, the hydraulic capacity of the hydraulic cylinder of the damper is between 3.5 Ml/100 bar and 4.5 Ml/100 bar and, in the second actuation direction, in particular in the compression direction, the piston is between 2 Ml/100 bar and 3 Ml/100 bar.

The hydraulic capacity of the hydraulic oil in an airless state is preferably between 1.6 Ml/100 bar and 1.9 Ml/100 bar and, in an air-containing state, preferably between 2.2 Ml/100 bar and 2.7 Ml/100 bar.

The hydraulic capacity of the hoses of the tube-hose system is between 5.1 and 5.5 Ml/100 bar at a hose length of 0.33 m.

These hydraulic capacities of the individual components of the damping system are particularly preferable in order to ensure advantageous dynamic and acoustic properties of the damping system at a low weight and requiring little installation space.

The hydraulic capacity of the tubes in the tube-hose system is negligibly low. The hydraulic capacity of the tube lines in the hydraulic unit is also negligibly low. The hydraulic capacity of the hydraulic reservoir of the hydraulic unit is irrelevant for providing advantageous dynamic and acoustic characteristics of the damping system because the hydraulic reservoir always cooperates with the hydraulic chamber of the hydraulic cylinder of the damper, where the pressure is lower than in the other hydraulic chamber, from which hydraulic oil is being discharged. The hydraulic capacity of the hydraulic reservoir is only used to provide a preloading pressure for the damping system within desired limits.

### BRIEF DESCRIPTION OF THE DRAWINGS

Preferred embodiments of the invention follow from the description hereinafter. Embodiments of the invention will be explained in greater detail with reference to the drawings, without being restricted thereto. Shown are:

FIG. 1 is a schematic representation of a damping system of an active chassis of a motor vehicle for a wheel of the motor vehicle.

### DETAILED DESCRIPTION OF THE INVENTION

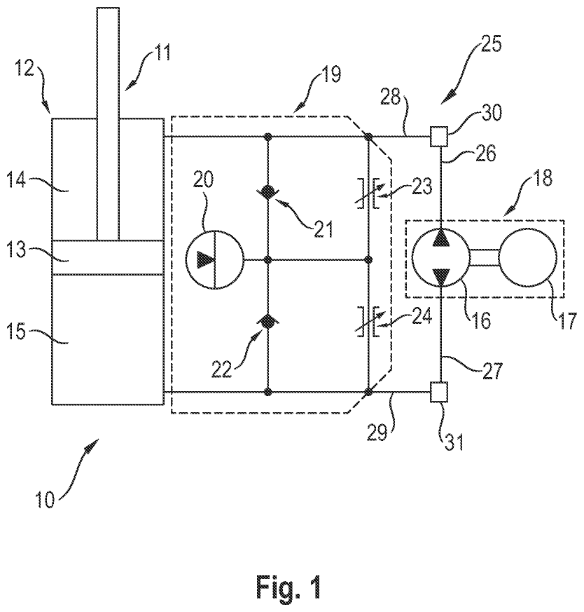

FIG. 1 shows a quite schematic view of a damping system 10 of an active chassis according to aspect of the invention for a wheel of a motor vehicle.

The damping system 10 comprises a damper 11 which is couplable to a wheel suspension system (not shown) for the wheel (not shown). The damper 11 is formed by a double-acting hydraulic cylinder 12 and a piston 13, whereby the piston 13 reciprocates back and forth in the hydraulic cylinder 12 (up and down in FIG. 1).

The hydraulic cylinder 12 designed as a double-acting hydraulic cylinder comprises a hydraulic chamber 14, 15 on each side of the piston 13. Depending on which of the two hydraulic chambers 14, 15 are being supplied with hydraulic oil and which of the two hydraulic chambers 15, 14 hydraulic oil is being discharged from, the piston 13 can be displaced in either a first actuation direction or an opposing second actuation direction. It is assumed hereinafter that the first actuation direction of the piston 13 is a rebound direction actuation, and the second actuation direction of the piston 13 is a compression direction actuation.

The damping system 10 further comprises a hydraulic pump 16 that is driveable by an electric motor 17. The hydraulic pump 16 and the electric motor 17 form a pump-motor unit 18. The hydraulic pump 16 is a reversing pump that can be driven in different rotational directions in order to provide different conveying directions.

The damping system 10 of FIG. 1 further comprises a hydraulic unit 19 having a hydraulic reservoir 20 as well as valves 21, 22, 23, 24. Valves 21, 22 are check valves, and valves 23, 24 are damping valves. The hydraulic reservoir 20 in each case engages between the check valves 21, 22 and between the damping valves 23, 24 on tubing of the hydraulic unit 19 coupled to the hydraulic chambers 14, 15 of the hydraulic cylinder 12.

Depending on the conveying direction of the hydraulic pump 16 and preferably also depending on the position of the valves 21, 22, 23, 24 of the hydraulic unit 19, in order to move the piston 13 in the first direction of movement, i.e., in the rebound direction, oil is supplied to the hydraulic chamber 14 and oil is removed from the hydraulic chamber 15. Or, in order to provide a second direction of movement of the piston 13 in the second direction of movement, i.e., the compression direction, oil is supplied to the hydraulic chamber 15 and oil is removed from the hydraulic chamber 14.

The hydraulic pump 16 of the pump-motor unit 18 is connected to the hydraulic unit 19 comprising the hydraulic reservoir 20 and the valves 21, 22, 23, 24, which unit is preferably installed as a unit on the damper 11, or installed on or integrated into the hydraulic cylinder 12 via a tube-hose system 25.

In the preferred embodiment, starting from the hydraulic pump 16, first tubes 26, 27 and then hoses 28, 29 extend towards the hydraulic unit 19 and thereby towards the hydraulic cylinder 12. Contiguous tubes and hoses are connected to each other via coupling means 30, 31.

The hydraulic pump 16 is coupled to respective connections of the hydraulic unit 19 for the hydraulic pump 16 via a respective tube 26, 27 and a respective hose 28, 29, and coupled to one of the two respective hydraulic chambers 13, 14 of the hydraulic cylinder 12 via the hydraulic unit 19, specifically the tube lines of the hydraulic unit 19.

The hydraulic cylinder 12 of the damper 11 and the tube-hose system 25 of the damping system 10, as well as the hydraulic oil used in the damping system 10, feature a combined hydraulic capacity of between 9 mL/100 bar and 14 mL/100 bar.

Given a hydraulic capacity of between 9 mL/100 bar and 14 mL/100 bar, which can above all be advantageously provided by the use of the tube-hose system 25, both advantageous dynamic properties and advantageous acoustic properties of the damping system 10 can be provided at a low weight and requiring little installation space. In this case, a high force gradient can then be ensured to provide advantageous dynamic properties. On the other hand, the damping system 10 tends toward low noise levels, thus providing advantageous acoustic properties.

The hydraulic cylinder 12 of the damper 11 and the tube-hose system 25 of the damping system 10, as well as the hydraulic oil used in the damping system 10, in the first direction of the piston 13, in particular in the rebound direction, feature a combined hydraulic capacity of between 10 mL/100 bar and 14 mL/100 bar, preferably between 11 mL/100 bar and 13 mL/100 bar, particularly preferably between 11.5 mL/100 bar and 12.5 mL/100 bar. In the second direction of actuation of piston 13, in particular in the compression direction, the hydraulic cylinder 12 of the damper 11 and the tube-hose system 25 of the damping system 10, as well as the hydraulic oil used in the damping system 10, feature a hydraulic capacity of between 9 mL/100 bar and 12 mL/100 bar, preferably between 10.5 and 11.5 mL/100 bar, particularly preferably between 10 mL/100 bar and 11 mL/100 bar. In the first actuation direction of the piston 13, in particular in the rebound direction, the above hydraulic capacity is in particular 12.0 mL/100 bar and, in the second actuation direction of the piston 13, in particular in the compression direction, the hydraulic capacity is in particular 10.5 mL/100 bar.

The above hydraulic capacities depend on the hydraulic capacity of the hydraulic cylinder 12 of the damper 11, the hydraulic capacity of the tube-hose system 25, and the hydraulic capacity of the hydraulic oil.

In the first actuation direction of the piston 13, preferably in the rebound direction, the hydraulic capacity of the hydraulic cylinder 12 of the damper is between 3.5 mL/100 bar and 4.5 mL/100 bar, in particular 4.0 mL/100 bar. In the second actuation direction of piston 13, in particular in the compression direction, the hydraulic capacity of hydraulic cylinder 12 of the damper 12 is between 2 mL/100 bar and 3 mL/100 bar, in particular 2.5 mL/100 bar.

In an airless state, the hydraulic oil features a hydraulic capacity of between 1.6 mL/100 bar and 1.9 mL/100 bar and, in an air-containing state, a hydraulic capacity of between 2.2 mL/100 bar and 2.7 mL/100 bar.

The tubes 26, 27 of the tube-hose system 25 are preferably made of a metallic material and are therefore relatively stiff and slightly elastic. The hydraulic capacity of the tubes 26, 27 of the tube-hose system 25 is negligibly low. The tubes 26, 27 of the tube-hose system 25 feature a negligibly low or zero hydraulic capacity.

The hydraulic capacity of the hoses 28, 29 of the tube-hose system 25 is between 5.1 mL/100 bar and 5.5 mL/100 bar, preferably between 5.2 mL/100 bar and 5.4 mL/100 bar, again at a hose length of 0.33 m. This hydraulic capacity of the hoses 28, 29 is the total hydraulic capacity of all of the hoses 28, 29.

The hoses 28, 29 are preferably made of a rubber-fiber material, whereby at least one layer of a fiber material is arranged between an outer layer of a rubber material and an inner layer of a rubber material. If two layers of a fiber material are arranged between the outer and inner layers of the rubber material, it is in particular provided that a further inner layer of a rubber material is arranged between the two layers of the fiber material.

It is within the meaning of the present invention to provide a damping system 10 of an active chassis for a wheel of a motor vehicle, whereby the pump 16 of the pump-motor unit 18 is connected to the hydraulic unit 19, which is preferably installed on the damper 12 and comprises the hydraulic reservoir 20 as well as valves 21, 22, 23, 24 both via tubes 26, 27 and via hoses 28, 29 of a tube-hose system 25, whereby across the length of the hoses 28, 29 in particular the hydraulic capacity is adjusted such that, when the piston 13 is displaced on the side of the higher hydraulic chamber pressure of the hydraulic cylinder 12, a hydraulic capacity is provided of between 9 mL/100 bar and 14 mL/100 bar, in the rebound direction in particular of 12 mL/100 bar, and in the compression direction of 10.5 mL/100 bar.

The hydraulic capacity of the tubes 26, 27 in the tube-hose system 25 is negligibly low. The hydraulic capacity of the tube lines in the hydraulic unit 19 is also negligibly low.

The hydraulic capacity of the hydraulic reservoir 20 of the hydraulic unit 19 is irrelevant with regard to providing advantageous dynamic and acoustic characteristics of the damping system because the hydraulic reservoir 20 always cooperates with the hydraulic chamber of the hydraulic cylinder 12 of the damper 11, where the pressure is lower than in the hydraulic chamber which hydraulic oil is being discharged from.

The hydraulic capacity of the hydraulic reservoir 20 is only used to provide a preload pressure for the damping system 10 within desired limits.

The hydraulic capacity is also referred to as hydraulic elasticity and defines a volume change in the event of a pressure change. The hydraulic capacities refer in each case to a temperature of 20° C.

The damping system 10 according to aspect of the invention can provide excellent dynamic and acoustic properties at a low weight and requiring little installation space.

Preferably, such a damping system 10 is associated with each wheel of a motor vehicle. It is also possible to associate both of the axle wheels on only one axle with a respective damping system 10 according to aspect of the invention.

What is claimed is:

1. A damping system of an active chassis of a motor vehicle for a wheel of the motor vehicle, said damping system comprising:
a damper including a double-acting hydraulic cylinder and a piston, which damper is configured to be coupled to a wheel suspension system for the wheel;
a hydraulic pump; and
a hydraulic unit comprising a hydraulic reservoir and valves,
wherein the hydraulic pump and the hydraulic unit cooperate with hydraulic chambers of the hydraulic cylinder such that, depending on a direction of conveyance of the hydraulic pump, a movement of the piston in a first direction of actuation or in a second direction of actuation can be provided,
wherein the hydraulic pump and the damper are connected via the hydraulic unit and a tube-hose system comprising tubes and hoses,
wherein the hydraulic cylinder of the damper and the tube-hose system of the damping system, as well as a hydraulic oil used in the damping system feature a combined hydraulic capacity of between 9 mL/100 bar and 14 mL/100 bar.

2. The damping system according to claim 1, wherein the hydraulic unit is installed on the damper or is integrated into the damper,
wherein the hydraulic pump is connected to the hydraulic unit installed on the damper via the tube-hose system such that, starting from the hydraulic pump, the tubes and then the hoses of the tube-hose system extend towards the hydraulic unit.

3. The damping system according to claim 1, wherein the hydraulic cylinder of the damper and the tube-hose system of the damping system, as well as the hydraulic oil used in the damping system, in the first actuation direction of the piston, which constitutes a rebound direction, feature a combined hydraulic capacity of between 10 mL/100 bar and 14 mL/100 bar.

4. The damping system according to claim 1, wherein the hydraulic cylinder of the damper and the tube-hose system of the damping system, as well as the hydraulic oil used in the damping system, in the second direction of operation of the piston, which constitutes a compression direction, feature a combined hydraulic capacity of between 9 mL/100 bar and 12 mL/100 bar.

5. The damping system according to claim 1, wherein in the first actuation direction of the piston, which constitutes a rebound direction, the hydraulic capacity of the hydraulic cylinder of the damper is between 3.5 mL/100 bar and 4.5 mL/100 bar, and/or
wherein in the second actuation direction of the piston, which constitutes a compression direction, the hydraulic capacity of the hydraulic cylinder of the damper is between 2 mL/100 bar and 3 mL/100 bar.

6. The damping system according to claim 1, wherein the hydraulic capacity of the hydraulic oil in an airless state is between 1.6 mL/100 bar and 1.9 mL/100 bar and, in an air-containing state, between 2.2 mL/100 bar and 2.7 mL/100 bar.

7. The damping system according to claim 1, wherein the hydraulic capacity of the hoses of the tube-hose system is between 5.1 mL/100 bar and 5.5 mL/100 bar at a tube length of 0.33 m.

8. The damping system according to claim 1, wherein the hoses of the tube-hose system comprise a rubber fiber material.

9. The damping system according to claim 1, wherein the tubes of the tube-hose system comprise a metallic material and feature a negligibly low or zero hydraulic capacity.

10. A motor vehicle having a plurality of wheels, wherein one of the wheels of at least one axle of the motor vehicle is associated with the damping system according to claim 1.
